(19) United States
(12) Patent Application Publication
(10) Pub. No.: US 2011/0132118 A1
(43) Pub. Date: Jun. 9, 2011

(54) Transmission component with functional structure

(75) Inventors: Ying-Lung Lin, Taichung (TW); Hsien-Feng Liu, Taichung (TW); Cheng-Wei Tung, Taichung (TW); Wen-Chung Tai, Taichung (TW)

(73) Assignee: Precision Machinery Research & Development Center

(21) Appl. No.: 12/653,020

(22) Filed: Dec. 7, 2009

(51) Int. Cl. F16H 55/02

(52) U.S. Cl. 74/431

(57) ABSTRACT

A transmission component with a functional structure has a linear or crossed shaft body, a transmission structure integrally formed on the shaft body and extending in a radial direction; a sensor matching structure and a shaft matching structure formed on the shaft body so that a sensor and a bearing may be conveniently assembled on the shaft body and the size of the transmission component can be miniaturized, and a reinforcing rod which may be inserted into the shaft body in an axial direction to enhance the structure intensity of the shaft body.

### BACKGROUND OF THE INVENTION

1. Field of the Invention

The invention relates to a transmission component of a joint of a robot, and more particularly to a transmission component having a functional structure to be combined with a sensor and/or a bearing.

2. Description of the Related Art

At present, the development issues of the robot include how to increase the agility of the robot and how to broaden the application range of the robot. Thus, many miniaturized joints having more degrees of freedom have been discussed and developed.

In order to increase the agility and enlarge the movement range, a mechanism having two shafts intersecting with each other is usually adopted at the position of the joint. This mechanism includes a cruciform shaft serving as the transmission component, one end of which is connected to a link, and the other end of which is connected to a flexible component. The flexible component is connected to a belt disk or a coupler so that the power may be transmitted through the cruciform shaft to move the link.

U.S. Pat. No. 6,917,175 discloses a cruciform shaft serving as a joint member. However, this transmission mechanism needs more components, so the manufacturing cost is high. Furthermore, the more components need to satisfy the assembling and mounting methods, so the size of the component cannot be easily miniaturized.

In addition, U.S. Pat. No. 5,765,443 discloses a transmission component disposed between two links. The transmission component is a power transmission member combined with a U-shaped rotor, wherein the power transmission member is to be connected to a power source, and the U-shaped rotor serves as a swinging member for driving the links to swing or rotate.

This mechanism needs the power transmission member to be combined with the U-shaped rotor, and the U-shaped rotor additionally needs to be formed with a pin hole through which a pin passes. So, this mechanism still has many combination positions. In order to satisfy the demands of the combination and installation, the size of this mechanism cannot be easily miniaturized, and the manufacturing cost thereof is high.

### SUMMARY OF THE INVENTION

It is therefore an objective of the invention to provide a transmission component, which has a functional structure and a miniaturized size, and can be easily manufactured.

Another objective of the invention is to provide a transmission component having a functional structure, wherein the transmission component may be combined with another member made of a material different from that of the transmission component so that the structure intensity thereof is sufficient while the size thereof is small.

In accordance with the present invention, there is provided a transmission component including a linear shaft body or a crossed shaft body, wherein a transmission structure extends in a radial direction of the shaft body and is integrally formed on the shaft body. Next, a sensor matching structure and a shaft matching structure are respectively formed on the shaft body so that the size can be miniaturized. Furthermore, a reinforcing rod may be inserted into the shaft body in an axial direction so that the structure intensity of the shaft body can be enhanced.

Further benefits and advantages of the present invention will become apparent after a careful reading of the detailed description with appropriate reference to the accompanying drawings.

### BRIEF DESCRIPTION OF THE DRAWINGS

The above and other objects of the present invention will become readily apparent by reference to the following detailed description when considered in conjunction with the accompanying drawings wherein:

FIG. 1 is a schematic illustration showing the invention applied to a palm and fingers.

FIG. 2 is another schematic illustration showing the invention applied to a palm and fingers.

FIG. 3 is an exploded view showing the exterior of the invention and the matching assembly.

FIG. 4 is a schematically assembled illustration showing the invention.

FIG. 5 shows the exterior of a rectangular sensor matching structure of the invention.

FIG. 6 shows the exterior of a slotted sensor matching structure of the invention.

FIG. 7 shows the exterior of a cruciform sensor matching structure of the invention.

FIG. 8 shows the exterior of the structure of two shafts intersecting with each other according to the invention.

FIG. 9 is a schematic illustration showing the structure of two shafts intersecting with each other according to the invention.

### DETAILED DESCRIPTION OF THE INVENTION

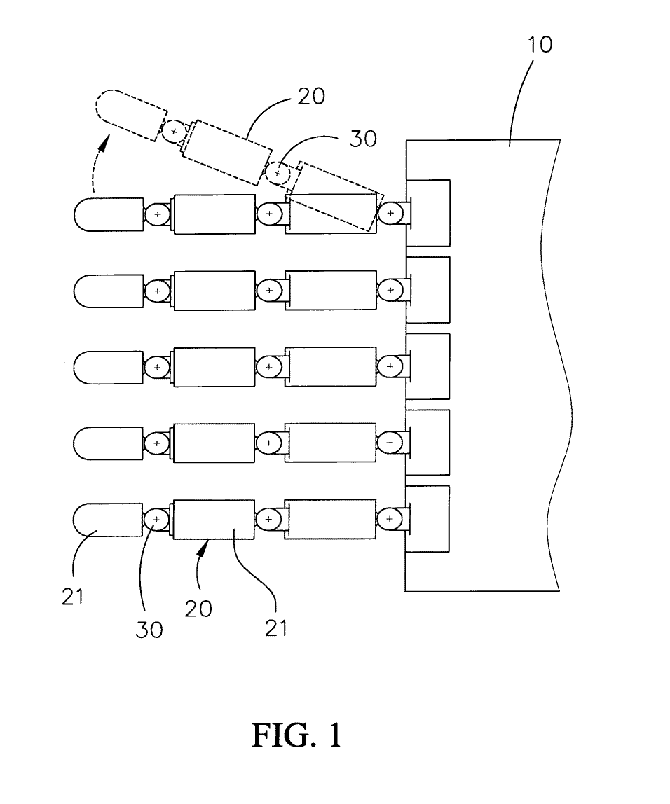

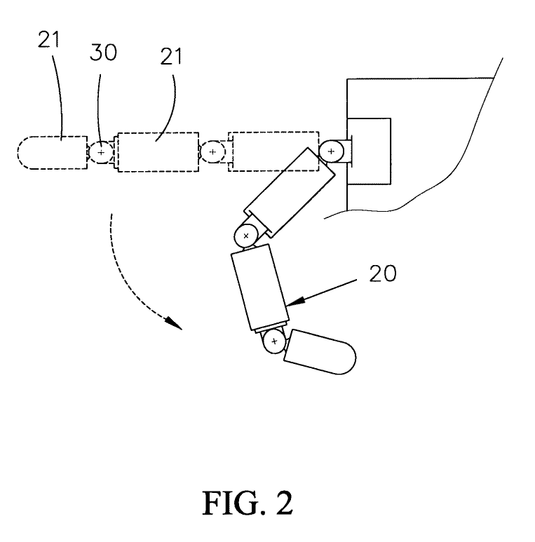

FIGS. 1 and 2 show a palm 10 and a plurality of fingers 20 of a robot. A transmission component 30 is disposed between the palm 10 and the finger 20. The transmission component 30 can receive and transmit power. Thus, the finger 20 can swing relatively to the palm 10 through the transmission component 30, and also can enter a relaxed state.

Also, the finger 20 is composed of a plurality of finger units 21. As for the same finger 20, one transmission component 30 is disposed between the neighboring finger units 21.

FIG. 1 discloses that the transmission component 30 is disposed at the joint position between the palm 10 and the finger 20 of the robot. However, the transmission component 30 may also be disposed on the foot or other joint positions according to the same principle.

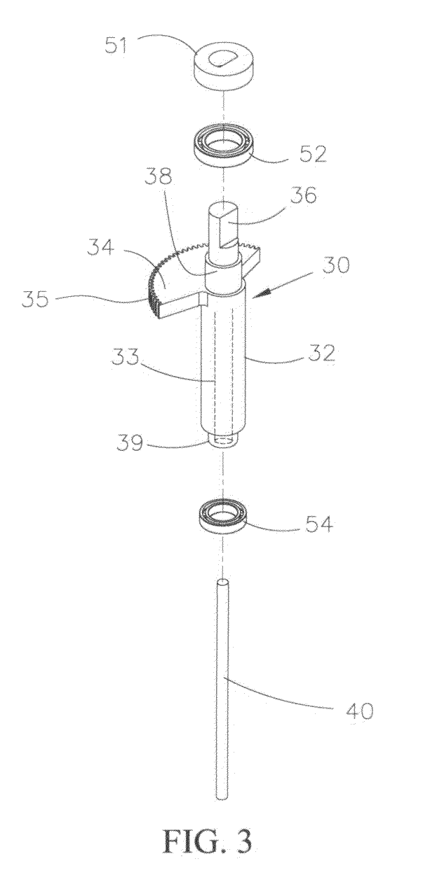

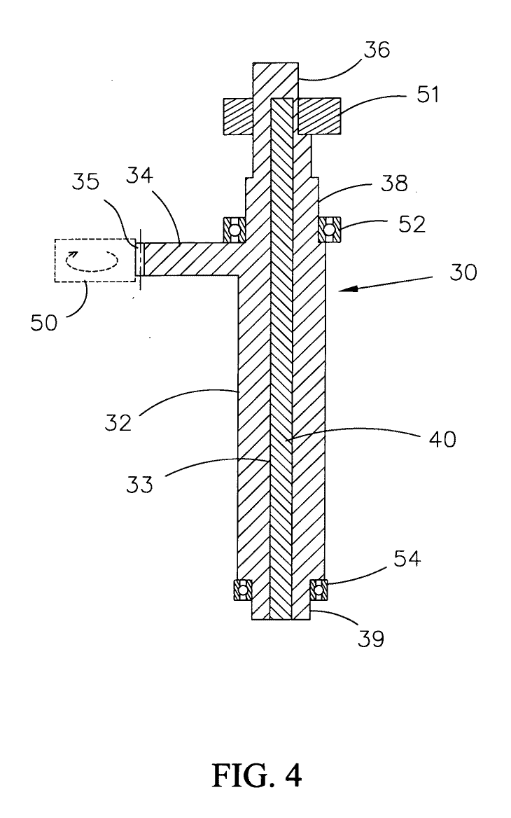

Referring to FIGS. 3 and 4, the transmission component 30 has a shaft body 32 having a linear structure, and a transmission structure 34 extending in a radial direction of the shaft body 32 and integrally formed on the shaft body 32. More particularly, the transmission structure 34 is a gear with a fan-shaped structure, and the outer edge of the gear has a toothed portion 35 with an angle at the center, which is greater than 90 degrees. The transmission structure 34 is connected to a torque device or system 50 (see FIG. 4).

A sensor matching structure 36 is formed at one end of the shaft body 32. According to the special exterior shape, such as a D shape, of the sensor matching structure 36, a sensor 51 can be combined with the sensor matching structure 36 without the rotation relative to the shaft body 32. The sensor 51 may be an angle sensor or an angular velocity sensor.

A bearing matching structure 38 is formed on the shaft body 32 and is a projecting ring body. A bearing 52 is disposed on the bearing matching structure 38. Also, another bearing matching structure 39 is formed on and extends from one end of the shaft body 32 and has a projecting rod-like structure. A bearing 54 is disposed on the bearing matching structure 39.

A reinforcing rod 40 is inserted into the shaft body 32 in the axial direction. More particularly, the shaft body 32 has an axial slot 33, into which the reinforcing rod 40 may be inserted. The reinforcing rod 40 and the shaft body 32 are made of different materials, and the hardness of the reinforcing rod 40 may be greater than the hardness of the shaft body 32.

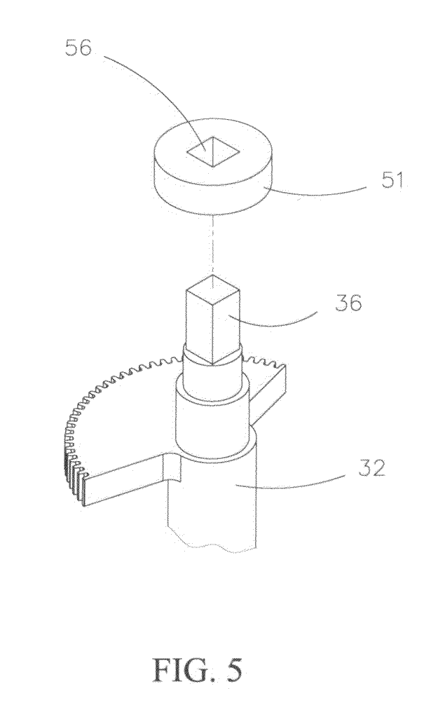

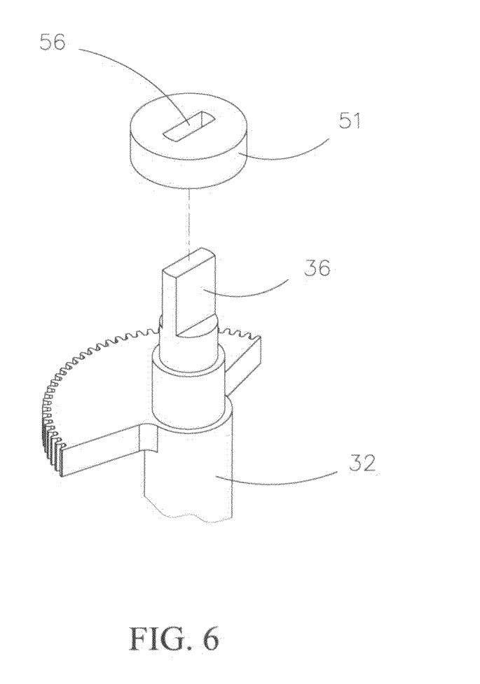

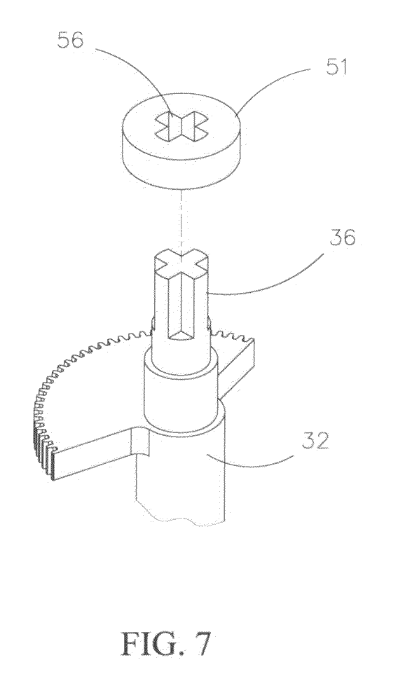

As shown in FIGS. 5 to 7, the sensor matching structures 36 on the one end of the shaft body 32 respectively have a rectangular structure, a slotted structure and a cruciform structure, which respectively correspond to the assembling holes 56 with different shapes on the sensor 51.

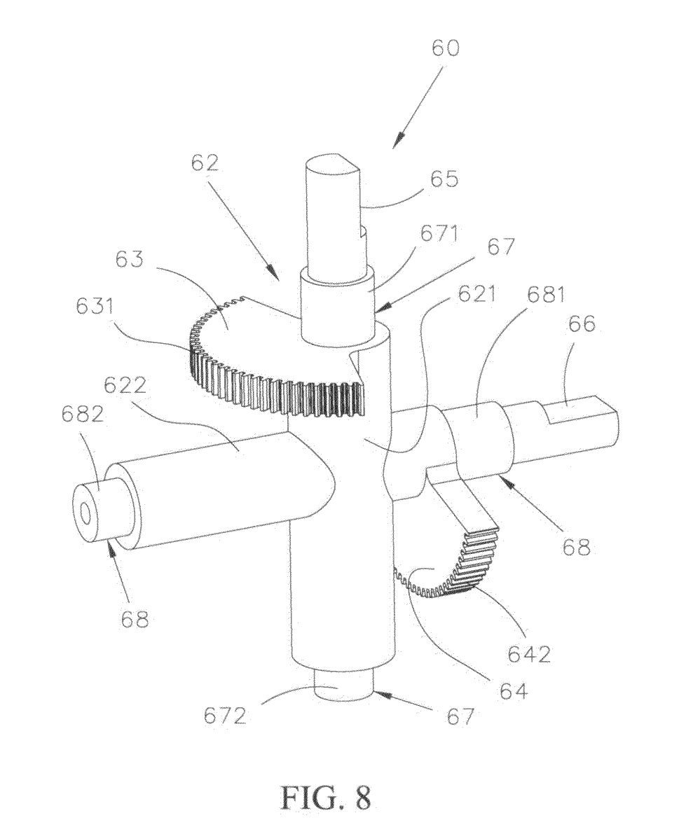

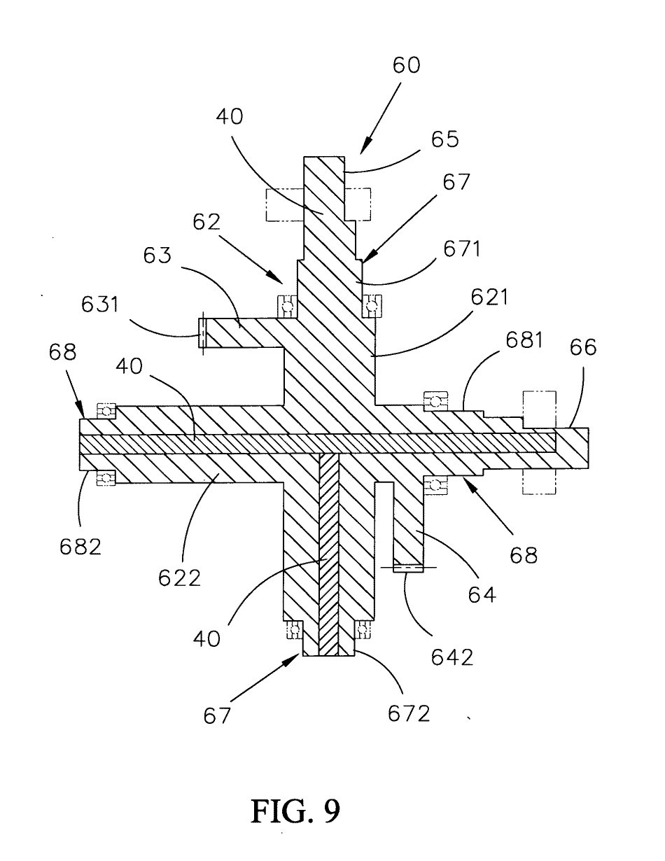

FIGS. 8 and 9 show the structure of two shafts intersecting with each other according to the invention. Referring to FIGS. 8 and 9, a transmission component 60 has a shaft body 62, which is composed of a first shaft 621 and a second shaft 622 intersecting with the first shaft 621.

A first transmission structure 63 extends in the radial direction of the first shaft 621 and is integrally formed on the first shaft 621. A second transmission structure 64 extends in a radial direction of the second shaft 622 and is integrally formed on the second shaft 622. Each of the first transmission structure 63 and the second transmission structure 64 is a gear with a fan-shaped structure. Each of an external first toothed portion 631 of the first transmission structure 63 and an external second toothed portion 642 of the second transmission structure 64 is connected to a torque device or system (not shown).

A first sensor matching structure 65 is formed at an end portion of the first shaft 621. A second sensor matching structure 66 is formed at an end portion of the second shaft 622.

In addition to the D-shaped structure, the first sensor matching structure 65 and the second sensor matching structure 66 may also have the rectangular, slotted or cruciform structures to match with the sensors with different shapes of assembling holes according to the teachings of FIGS. 5 to 7. In addition, the relative rotation between the sensor and the shaft body 62 is limited using the non-circular shape so that the sensor can sense the rotation of the two shafts more precisely.

A first bearing matching structure 67 is disposed on the first shaft 621. The first bearing matching structure 67 has a first projecting ring body 671 and a first projecting cylinder 672. The first projecting ring body 671 is formed on the surface of the first shaft 621. The first projecting cylinder 672 is integrally formed on and extends from the end portion of the first shaft 621.

A second bearing matching structure 68 is disposed on the second shaft 622. The second bearing matching structure 68 has a second projecting ring body 681 and a second projecting cylinder 682. The second projecting ring body 681 is formed on the surface of the second shaft 622. The second projecting cylinder 682 is integrally formed on and extends from the end portion of the second shaft 622.

The first bearing matching structure 67 and the second bearing matching structure 68 may be respectively combined with suitable bearings.

In addition, as shown in FIG. 9, it is obtained that the reinforcing rods 40 may be respectively inserted into the first shaft 621 and the second shaft 622 in the axial directions, and the reinforcing rod 40 and the shaft body 62 are made of different materials. For example, the hardness of the reinforcing rod 40 is greater than the hardness of the shaft body 62 so that the structure intensity of the shaft body 62 can be enhanced.

Thus, the transmission component 30 or 60 according to the invention has the matching structure and the transmission structure with the specific shapes on the shaft body 32 or 62. So, the size of the transmission component can be miniaturized. In addition, the sensor and the bearing may be directly disposed on the matching structure and the transmission structure with the specific shapes in the transmission component 30 or 60, and the transmission component may be connected to the torque device so that the transmission component can be conveniently manufactured and assembled. In addition, the structure intensity can be effectively enhanced according to the reinforcing rod 40 inserted into the shaft body 32 or 62. In addition, the transmission component 30 or 60 with the functional structure can be directly connected to the torque device so that the effect of direct linking-up and the effect of reducing the moving space of the mechanism can be achieved.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A transmission component with a functional structure, the transmission component is to be disposed at a joint of a robot, the transmission component comprising:
a shaft body having a linear structure;
a transmission structure extending in a radial direction of the shaft body and integrally formed on the shaft body;
a sensor matching structure formed at one end of the shaft body; and
a bearing matching structure formed on the shaft body.

2. The transmission component according to claim 1, wherein the transmission structure is a fan-shaped gear having a toothed portion formed on an external side.

3. The transmission component according to claim 1, wherein the sensor matching structure is selected from a slotted structure, a rectangular structure, a D-shaped or a cruciform structure.

4. The transmission component according to claim 1, wherein the bearing matching structure is a projecting ring body integrally formed on the shaft body.

5. The transmission component according to claim 1, wherein the bearing matching structure is a projecting cylinder integrally extending from an end portion of the shaft body.

6. The transmission component according to claim 1, further comprising a reinforcing rod inserted into the shaft body in an axial direction.

7. The transmission component according to claim 6, wherein the reinforcing rod and the shaft body are made of different materials.

8. The transmission component according to claim 6 or 7, wherein a hardness of the reinforcing rod is greater than a hardness of the shaft body.

9. A transmission component with a functional structure, the transmission component is to be disposed at a joint of a robot, the transmission component comprising:
a shaft body having a first shaft and a second shaft crossed with the first shaft;
a first transmission structure extending in a radial direction of the first shaft and integrally formed on the first shaft;
a second transmission structure extending in a radial direction of the second shaft and integrally formed on the second shaft;
a first sensor matching structure formed at one end of the first shaft; and
a second sensor matching structure formed at one end of the second shaft.

10. The transmission component according to claim 9, further comprising a first bearing matching structure, which has:
a first projecting ring body formed on a surface of the first shaft; and
a first projecting cylinder integrally formed on and extending from an end portion of the first shaft.

11. The transmission component according to claim 9, further comprising a second bearing matching structure, which has:
a second projecting ring body formed on a surface of the second shaft; and
a second projecting cylinder integrally formed on and extending from an end portion of the second shaft.

12. The transmission component according to claim 9, wherein the first transmission structure is a fan-shaped gear having a first toothed portion formed on an external side.

13. The transmission component according to claim 9, wherein the second transmission structure is a fan-shaped gear having a second toothed portion formed on an external side.

14. The transmission component according to claim 9, wherein each of the first sensor matching structure and the second sensor matching structure is selected from a slotted structure, a rectangular structure, a D-shaped structure or a cruciform structure.

15. The transmission component according to claim 9, further comprising a reinforcing rod inserted into the first shaft or the second shaft of the shaft body in an axial direction.

16. The transmission component according to claim 15, wherein the reinforcing rod and the shaft body are made of different materials.

17. The transmission component according to claim 15 or 16, wherein a hardness of the reinforcing rod is greater than a hardness of the shaft body.
